(19) United States
(12) Patent Application Publication
(10) Pub. No.: US 2012/0234769 A1
(43) Pub. Date: Sep. 20, 2012

(54) Systems and methods for treating fluid media using nonthermal plasmas

(76) Inventor: Steven Bittenson, Bedford, MA (US)

(21) Appl. No.: 13/417,344

(22) Filed: Mar. 12, 2012

Related U.S. Application Data
(60) Provisional application No. 61/452,198, filed on Mar. 14, 2011.

(51) Int. Cl. C02F 1/52; C02F 1/72; C02F 1/62

(52) U.S. Cl. 210/721; 210/192

(57) ABSTRACT

Nonthermal plasma gas injection is applied in conjunction with other treatment means such as a precipitant, to effect chemical treatment of a liquid medium. The combined treatment performs one or more of chemically modifying a component of the medium, activating or enhancing the performance of a treatment material for the medium, and removing one or more chemical component from the medium. The nonthermal plasma can be applied directly in a liquid medium, in an aerosol of the medium, or to a treatment material in contact with or cycled into and out of the medium. Applications include removing contaminants including arsenic from drinking water.

### CROSS-REFERENCE TO RELATED APPLICATIONS

This application claims benefit of U.S. Provisional application No. 61/452,198 filed 14 Mar., 2011.

### FIELD OF THE INVENTION

The present invention relates generally to plasma-based devices, systems and methods, and particularly to the incorporation of nonthermal plasmas into treatments of liquids or liquid streams, for the removal or modification of chemical contaminants.

### BACKGROUND

The provision of clean water, including drinking water for human use, is increasingly appreciated as a critical need as the world population increases and as negative health effects from various naturally occurring as well as industrially originating contaminants become better understood. For example, the removal of arsenic and other toxic mineral contaminants from drinking water has been the subject of a great deal of study and development, as has the detoxification of biologically or organically contaminated water.

The removal or detoxification of undesirable components from water sources or other liquid media is currently addressed by various methods including heating, distillation, aeration, filtration, exposure to ultraviolet light or other radiation, various chemical treatments including precipitation, adsorption, ion exchange resins, reaction with chemical additives, and combinations thereof “Precipitation” as used herein encompasses not only the removal of a contaminant in the form of insoluble species, but also includes the immobilization of the contaminant on or in insoluble particles or other solid materials. The selection of an optimal treatment method among known treatment methods is based on the nature and concentration of the contaminant or contaminants, as well as on the economics and scalability of the applicable technologies.

Compositions containing rare earth elements have been shown to be particularly useful in treating contaminated water. For example, U.S. Pat. No. 7,338,603 (McNew et al.) discloses sorbents comprising rare earth compounds for removing inorganic oxyanions from an aqueous stream. U.S. Pat. No. 7,686,976 (Witham et al.) discloses the use of rare earth oxides to provide oxidation of arsenic in the +3 oxidation state to the +5 oxidation state (for example, converting arsenite to arsenate) toward the subsequent removal of arsenic from the stream by a rare earth-containing precipitating agent. Witham et al., further discloses that “The oxidation and precipitation steps can be carried out in the same or separate zones” providing for sequential treatments that include separate oxidation and precipitation steps, and treatments wherein “the precipitation occurs essentially simultaneously with the oxidation.”

Pending U.S. patent application Ser. No. 12/721,233 (Burba et al.) discloses the use of an aggregate comprising rare earth compounds, that can be used in conjunction with oxygen-enriched air, ozone or hydrogen peroxide for treating contaminated water streams. These three references: U.S. Pat. No. 7,686,976, U.S. Pat. No. 7,338,603, and U.S. Ser. No. 12/721,233 are hereby incorporated herein in their entirety by reference.

Decontamination agents and systems generally have a limited capacity to treat a volume of a fluid or a process stream, and require periodic replenishment, replacement, recycling, regeneration or reactivation, such processes often involving removal of at least the decontamination agent from the process stream, and commonly comprising a principal cost of using the treatment technology. With growing global awareness of the broad systems and environmental implications of many industrial and chemical processes, it has become better appreciated that there is a need to develop technologies, including purification or decontamination technologies, that optimize product life, minimize the consumption of raw materials, and that enable or improve recycling of materials that are used in these processes.

### SUMMARY OF THE INVENTION

The present invention relates to the application of nonthermal plasma devices for treating fluid media, in combination with complementary fluid treatment materials and methods. One aspect of the present invention is a system for removing a contaminant from an aqueous medium. The system includes a gas injector configured to electrically excite a gas and to inject the exited gas into the medium. In various embodiments, the gas in injected into the medium at a temperature of less than four hundred degrees Celsius or less than one hundred degrees Celsius. The injected gas includes a gaseous oxidant generated by the electrical excitation and having a persistence time in the gas of less than five seconds. In embodiments, the persistence time is less than one second or less than one hundred milliseconds. The oxidant is operative to oxidize the contaminant from a first chemical state to a second chemical state and in various embodiments includes one or more of atomic oxygen, ionized molecular oxygen, an oxygen-containing chemical species excited above a ground quantum state, and hydroxyl.

A precipitating agent having a capacity to remove the contaminant from the medium is in contact with the medium, the removal capacity of the precipitating agent being greater for the contaminant in the second state than in the first state. The medium can be a liquid in which the injector is at least partially immersed, or a dispersion of liquid drops in a gas, for example, an aerosol of contaminant-containing droplets in air. In an embodiment, the contaminant comprises arsenic in a +3 oxidation state that is oxidizable by the oxidant to arsenic in a +5 oxidation state.

The precipitating agent can be a rare earth precipitating agent that can include cerium and that has a greater capacity to precipitate arsenic present in the +5 oxidation state, than its capacity to precipitate arsenic present in the +3 oxidation state. The precipitating agent can have any of various physical forms, including solid forms, retention on a porous substrate, or configured as or in an aggregate or slurry. The gas injector and the precipitating agent can be positioned apart or proximate to one another so that a portion of the injected oxidant contacts the precipitating agent during the persistence time.

Another aspect of the invention is a method for removing arsenic in a +3 oxidation state from an aqueous medium that can be a liquid or a suspension of liquid droplets in a gas. The method includes oxidizing the arsenic from the +3 oxidation state to a +5 oxidation state by injecting a gaseous oxidant into the medium, the oxidant having a persistence time in the medium of less than five seconds, and precipitating the oxidized arsenic from the medium by contacting the medium with a precipitating agent having a greater capacity to precipitate arsenic present in the +5 oxidation state than present in the +3 oxidation state. In an embodiment, the oxidant includes one or more of atomic oxygen, ionized molecular oxygen, an oxygen-containing chemical species excited above a ground quantum state, and hydroxyl. The precipitating agent can be a rare earth precipitating agent that can include cerium in its composition.

### BRIEF DESCRIPTION OF THE DRAWINGS

This invention is described with particularity in the appended claims. The above and further aspects of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIGS. 1A and 1B schematically illustrate exemplary embodiments of fluid treatment systems according to the present invention.

FIG. 2 schematically illustrates a fluid stream treatment system according to the present invention comprising reconditioning of a treatment material.

### DESCRIPTION

The invention relates generally to plasma-based devices, systems and processes, and particularly to the incorporation of nonthermal plasmas in the treatment of liquid media, for the removal or modification of chemical contaminants in the media. Novel systems and processes according to the present invention comprise the synergistic integration of nonthermal plasma technology with other treatment technologies. In various embodiments, media subject to treatment according to the present invention can comprise a volume of fluid contained in a vessel, or fluid flowing through or along a conduit.

Systems and processes process of the present invention are envisioned for treating a variety of contaminants in aqueous media, but can be particularly advantageous for removing dissolved arsenic and other inorganic contaminants from water intended directly or indirectly for human consumption or other use. Applications of the inventive technology include but are not limited to treating drinking water, groundwater, well water, surface waters such as water from lakes, ponds and wetlands, agricultural waters, wastewater from industrial processes, and geothermal fluids. Nonlimiting examples of inorganic contaminants that can be treated using the present invention include arsenic, selenium, cadmium, lead and mercury. Processes and systems according to the present invention can also be used to treat or enhance the treatment of certain organically contaminated liquid feeds, and particularly organic contaminants susceptible to treatment that includes oxidative processes.

Nonthermal plasma technology refers herein to systems, devices and methods that generate chemical reactants in the form of transient reactive chemical species (transient species) in a gas without heating the gas to high temperatures at which thermal processes would dominate the interactions of the gas with other materials. A nonthermal plasma (NTP) treatment device according to the present invention is any device wherein a gas is activated by an application of energy thereto, to form a nonequilibrium concentration therein of one or more highly reactive or excited transient species, the gas bearing the transient species being ejected from the NTP device quickly enough following the activation that the concentration of the one or more transient species is effective to react with or otherwise treat a medium external to the device before the transient species is removed or rendered inactive by inherent deactivation or relaxation processes such as radiative or collisional relaxation, or recombination of dissociated chemical species, for example, atomic oxygen generated from molecular oxygen recombining to re-form molecular oxygen. These deactivation processes for the transient species produced by NTP devices according to the present invention define transient species effective lifetimes, also called persistence times, defined herein as a time for half of the concentration of the transient species to be deactivated before it can be used in a treatment process. Transient species according to the present invention have persistence times dependent on the nature of the species and environmental conditions following their formation, but are shorter than approximately five seconds and nearly always shorter than one second. Commonly, the transient species have persistence times of less than one hundred milliseconds, for example for many recombination or vibrational relaxation processes, and highly reactive or excited transient species may have radiative decay or collisional relaxation or recombination times in the range of one microsecond to ten milliseconds.

In contrast with hot plasma devices such as plasma-based torches that thermally, typically nonselectively and often destructively, treat a medium with gas temperatures up to several thousand degrees Celsius, activated gases from NTP devices as disclosed herein are typically provided at average temperatures ranging from only slightly above a local ambient temperature or the temperature of a feed gas from a gas supply, up to only several hundred degrees Celsius, and further are rapidly mixed and diluted upon delivery, enabling the transient species to chemically react selectively in the medium being treated, and not dominated by heating the medium. In one embodiment a nonthermal plasma injection device according to the present invention injects gas bearing transient species operative to treat a medium, with the gas exiting the injector at a temperature of less than approximately four hundred degrees Celsius. In another embodiment, the temperature of the gas exiting the injector is less than approximately 100 degrees Celsius. In another embodiment, the gas exiting the injector is at a higher temperature but reduced to an average temperature of less than approximately 100 degrees celsius within 10 to 100 milliseconds following injection into the medium. Further, nonthermal plasma devices of the present invention are distinct from reactive gas generators such as ozone generators, which comprise a well-established technology that provides moderately reactive but relatively stable ozone gas having a storage and handling half-life of several minutes to several hours and which can be generated in an off-line device and piped through conduits to the medium being treated.

Nonthermal plasma generation according to the present invention can include but is not limited to repetitively pulsed direct current (DC) discharges, alternating current (AC) discharges that can include radio frequency and microwave discharges, electron beam excitation, dielectric barrier discharges, and intense illumination with optical or other wavelength radiation. Operating criteria for particular nonthermal plasma devices are broadly determined by the physical configuration of the NTP device, the chemical nature and pressure of the gas supplied to the device, and chemical composition of the medium to be treated.

U.S. Pat. No. 6,030,506 (Bittenson et al.), which this disclosure hereby incorporates in its entirety by reference, discloses NTP jet injectors wherein repetitively pulsed electric discharges activate a pressurized gas adjacent to an exit orifice thereof. The gas bearing the activated transient chemical species exits the injector through the orifice at high velocity, for reaction with an external medium that can be another gas, a liquid including an aqueous liquid or slurry, or a solid surface. Although embodiments herein are generally described as comprising NTP jet injectors as disclosed in Bittenson et al., any NTP device providing concentrations of transient species effective for reaction with a subject medium are intended to be within principals and the inventive scope of the present invention.

In several embodiments, one or more NTP injector injects gas comprising one or more transient species directly into an aqueous medium to oxidize a chemical component of the medium. The gas injection may also provide agitation to the medium as the gas enters the medium and as gas bubbles rise therein. In an embodiment, the chemical component is arsenic in a first oxidation state that is oxidized to a second, higher oxidation state. In an embodiment, the chemical component is arsenite and the transient species oxidizes the arsenite to arsenate. In one embodiment, the NTP injector comprises a pulsed electric discharge in an oxygen-bearing gas that can include oxygen, air, synthetic mixtures of oxygen and nitrogen, or an admixture of oxygen in another diluent that is preferably a relatively chemically inert gas such as argon or helium. The injector activates and injects the gas including a transient species comprising activated oxygen, that is, oxygen that has been one or more of ionized, dissociated to atomic oxygen, excited above a ground quantum state (such as one or both of electronically and vibrationally excited), or otherwise rendered highly chemically reactive.

Oxygen-containing chemical species excited above a ground quantum state may exhibit enhanced oxidizing ability relative to the respective ground state species, and thereby be more operative than the ground state species to oxidize chemical constituents of a fluid medium to be treated by systems according to the present invention. Examples of oxygen-containing chemical species in the present context include but are not limited to atomic oxygen, molecular oxygen, ozone, hydroxyl and ionized variants of any of these chemical species. Depending on the concentration of water in the gas within or adjacent to the injector, hydroxyl (OH) or other water-derived oxidizing transient species may be generated by an NTP injector. Some ozone may also be generated and useful as a transient species, particularly if excited above a ground quantum state. According to the principles disclosed in Bittenson et al., the injector is designed to eject the transient species as quickly as is practical after generation, to maximize interaction time of the transient species with the medium to be treated before recombining or otherwise being deactivated. In an embodiment, the activation takes place primarily within a distance of two millimeters or less of the exit orifice and gas is ejected from the injector within approximately one microsecond to one hundred microseconds after excitation.

In addition to providing transient species for reaction in a medium to be treated, electromagnetic radiation can be emitted by a nonthermal plasma as its transient species decay. This radiation can comprise spontaneous emission from relaxing excited species, or emissions associated with heterogeneous chemical reactions or recombination reactions of dissociated species, for example, light emission from atomic nitrogen or atomic oxygen recombining to respective diatomic molecules. For example, nitrogen-bearing NTP injectors have been demonstrated to produce visible plumes of light-emitting plasma as much as 7 centimeters long in a gaseous environment, the light generated by a well-known specific emission process associated with atomic nitrogen recombining to form molecular nitrogen. The wavelength of the emitted radiation depends on the chemical composition, excitation, and delivery time of the nonthermal plasma from the injector.

In an embodiment, nonthermal plasma injected into a liquid medium or in proximity to a solid surface in contact with or adjacent thereto acts on the medium or the surface via emission of electromagnetic radiation (hereinafter, optical radiation) due to the presence of a specific transient species in the plasma. In an embodiment the optical radiation is one of ultraviolet, visible, or infrared light. Nonthermal plasma injected into a liquid medium produces gas bubbles in the liquid. Advantageously, optical radiation emitted due to the presence of transient species in a bubble is transmitted to the liquid or to a solid surface immersed in the liquid directly and relatively losslessly through a gas-liquid or gas-solid interface of the bubble. This is in contrast to known means for treating liquids with optical radiation using light-emitting lamps that transmit light to the liquid via nominally optically transparent materials comprising lamp walls or windows. All such optical materials degrade with age and can be subject to physical, thermal or optical damage, can be contaminated, coated or fouled during operation, or damaged directly by immersion in the liquid due to material incompatibilities. In addition, conventional light-based treatments typically comprise lamps that emit light from static locations within or adjacent to a medium to be treated, whereas light-emitting gas bubbles associated with NTP injection are mobile within the liquid, contributing to effective volumetric treatment of the liquid, whether in a static vessel or flowing stream.

In various embodiments, the transient species acts on a fluid medium by directly reacting with a contaminant in the medium, or by enhancing the activity of a complementary treatment element in or adjacent to the medium for treating the contaminant. The complementary treatment element can be one or more of, but is not limited to, a filter medium, a material that absorbs or chemically reacts with the contaminant, or a precipitant. In an embodiment, the complementary treatment element comprises one or more rare earth compound. In an embodiment the one or more rare earth compound includes a cerium oxide or another rare earth oxide.

In an embodiment, an NTP injector injects activated oxygen into a liquid process stream, where it oxidizes Arsenite to Arsenate, rendering the arsenic-bearing chemical species more amenable to removal by a precipitant or other removal means. In this embodiment, the NTP injector replaces purchased and stored chemical reagents in solid, liquid, aggregate or slurry form that would otherwise be required to modify the oxidation state of the arsenic in the stream. This and related embodiments thereby reduce raw material use as well as associated disposal or recycling cost associated with the removal or sequestration of toxic contaminants.

In another embodiment, activated gas from an NTP device is applied directly to a treatment material that can be one or more of a filter medium, a binding agent, an ion exchange material, or a chemical treatment agent comprising a rare earth-bearing composition, to activate or improve the performance of the treatment material. In an embodiment, the rare earth bearing material is a rare earth oxide. In these embodiments, the system is preferably configured such that the activated gas from the NTP device is directed to the treatment material during the persistence time of the transient species. In a further embodiment the rare earth is one of lanthanum, cerium, praseodymium, neodymium, promethium, samarium, europium, gadolinium, terbium, dysprosium, holmium erbium, thulium, ytterbium and lutetium. The effect of the NTP can be one or more of reactivation of a catalyst, changing an oxidation state of the chemical treatment material, or other chemical modification of the treatment material, for example, via chemical reduction or oxidation of a rare earth compound as required for a particular treatment process. In another embodiment, a transient species in the activated gas one or more of oxidizes, collisionally excites and optically irradiates a component of a liquid medium to be treated by the treatment material and which is in contact therewith or immediately adjacent thereto.

The NTP treatment can be applied continuously or intermittently to a liquid medium in combination with another treatment technology, or in a reactivation mode where a chemical treatment material (such as a rare earth bearing material) is temporarily removed from a medium to be treated, either in a batch process or using a recirculating apparatus such as a belt or drum. In an embodiment, while the treatment agent is outside the medium, a NTP device is used to reprocess the material, recovering its chemical usefulness for treating the medium. In one embodiment the treatment material comprises a rare earth compound used as an oxidizer in the medium, where it has a consumable capacity to oxidize a contaminant from a lower to a higher oxidation state, while the rare earth oxide is concomitantly reduced from a higher to a lower oxidation state. After oxidizing a predetermined amount of the contaminant, the treatment material is cycled out of the medium to be treated and itself treated using an oxidizing NTP device to regenerate the treatment material for oxidizing additional contaminant upon return to the fluid medium. In an embodiment, the medium is a flowing aqueous medium containing an inorganic contaminant, and reactivation of the treatment agent comprises substantially continuously cycling of a portion of the treatment agent out of the flowing medium for reactivation and returning it to the flowing medium for continued use.

A particular advantage of NTP injection devices as disclosed herein is that they can be applied in humid as well as dry conditions and ambient environments, a characteristic that is particularly important for operation in or adjacent an aqueous medium. By contrast, some other low temperature plasma devices employing, for example, volume-filling barrier discharges, function poorly or not at all in humid environments, where they may be subject to high voltage arcing, condensation and contamination issues, and dielectric barrier failure.

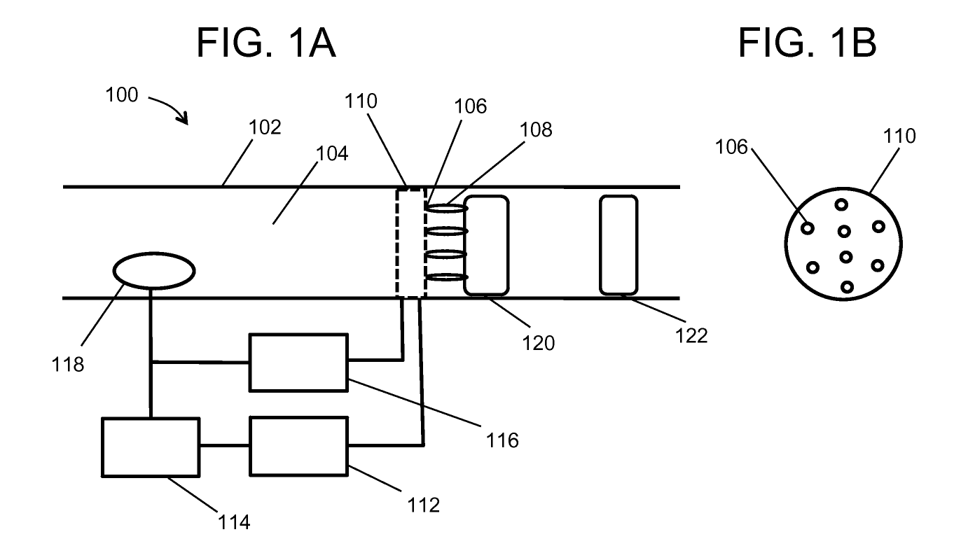

NTP injectors can be provided in many different physical configurations for treatment of a liquid medium that can be stationary or a flowing process stream. FIGS. 1A and 1B schematically illustrate exemplary embodiments of fluid treatment systems comprising NTP injectors. In FIG. 1A, a fluid treatment system 100 is seen to comprise a fluid containment device 102 that is illustrated in the figure as a longitudinal portion of an enclosed conduit for conducting a fluid 104 therethrough. Alternatively (not illustrated) the fluid containment device 102 comprises an open flowing channel for conducting the fluid 104, a vessel having a defined inlet and outlet for the passage of the fluid 104 therethrough, or a vessel for containing a volume of the fluid 104 for batch processing. In various embodiments, the fluid 104 is an aqueous fluid containing any of the contaminants disclosed herein, or any other contaminant treatable by the hereindisclosed systems and methods. In another embodiment, the fluid 104 comprises an aerosol, that is, a spray or mist of fluid droplets suspended in or passing through the containment device 102. Typically the aerosol would be of the fluid droplets in air, but any suitable gas can be used to suspend or carry the fluid droplets. The fluid containment device 102 comprises one or more NTP injection device 106, also illustrated in an end view in FIG. 1B, for injecting gas 108 bearing transient species into or adjacent to the fluid 104. The one or more NTP injection device 106 can comprise discrete injectors or a manifold 110 including any number of injectors, which preferably are positioned to optimize interaction of the transient species with the fluid 104. In flowing fluid systems, the one or more injection device 106 and the manifold 110 if present, are preferably configured to preserve fluid flow through the containment device 102. Nonlimiting examples of injector configurations include injectors positioned or arrayed about a circumference of the containment device 102 and directed into the fluid 104, or non-obstructively distributed across a fluid flow path within the containment device 102.

A gas handling system 112 is configured supply gas to the one or more injection device 106, via the manifold 110, if present. In one embodiment, the gas comprises at least one gaseous component that upon activation in an NTP device can act as an oxidant for oxidizing a chemical constituent of the fluid 104. In a further embodiment, the gaseous component is one of oxygen and an oxygen-containing chemical compound. The gas handling system 112 is configured to transport gas from a gas supply 114 to the one or more injection device 106 and in various embodiments includes one or more of a pressure regulator, flow regulator, particulate or chemical filter, distribution manifold components and other gas handling components known to persons skilled in this art. The gas supply 114 can be any gas source suitable for supplying gas to the one or more injector 106.

In one embodiment the gas supply 114 comprises one or more pressurized gas vessel, for example, gas stored in pressurized gas cylinders. In another embodiment the gas source 114 comprises a gas generation device. In one embodiment, air or a component of air comprises the gas supplied to the one or more injection device 106, and the gas source 114 comprises one or more of a compressor for pressurizing ambient air, a particulate filter, a gas drier (dehydrator), and a gas separator such as a membrane separator configured for modifying the concentrations of components of air. In another embodiment, the gas source comprises extraction of a gaseous component from a component of the fluid 104, for example, by electrolysis of water to produce oxygen for supplying to the one or more injection device 106. These and other gas generating technologies are well known to persons skilled in this art.

A power supply 116 is configured to provide excitation energy to the one or more injector 106 for activating the gas. The power supply 116 can comprise any source of energy suitable to activate the one or more injector 106 and can further include any manual or automated controls required or desirable for the system operation and safety, using electrical engineering technologies well known to persons skilled in these arts. Electrical power is required to operate the power supply 116 for energizing the one or more injection device 106. Further, in some embodiments where the gas source comprises a gas generation device, electrical power is also required to accomplish one or more of generating, separating and compressing a supply gas.

Although externally suplied electrical power can be used to power these system components, in systems where the fluid 104 comprises a flowing liquid stream, the stream may be utilizable to generate electrical power to operate the system 100. In an embodiment, a hydroelectric generation unit 118 is energized by flow of the fluid 104 or by fluid flow in another portion of a source stream for the fluid 104, with electrical power generated by the generation unit 118 configured to provide electrical power to one or both of the power supply 116 and the gas source 114. In one embodiment, electrical power from the generation unit 118 is stored for intermittently powering the system 100. In another embodiment, the system 100 is used to treat only a portion (a slipstream) of a larger flowing stream, and the generation unit 118 derives its power from the larger stream. In still other embodiments, other locally generated electrical power such as solar or wind power, is used to operate the system 100 or the local electrical power generation is integrated with the system 100.

In addition to the one or more NTP injection device 106, the fluid treatment system is seen to include at least one complementary treatment component 120, 122. In an embodiment the complementary treatment component comprises a precipitation system as defined herein, a filtration system, or another decontamination or detoxification system, the operation of which is enabled or enhanced by the one or more NTP injection device 106. The at least one complementary treatment component preferably comprises materials substantially insoluble in the fluid 104, such that the treatment material itself does not contaminate the fluid. Alternately, if the at least one complementary treatment component does include a soluble material, that material is either subsequently removable from the fluid 104 by another treatment step or not considered a contaminant in the fluid 104. In one embodiment, operation of the one or more NTP injection device 106 oxidizes an inorganic contaminant of the fluid 104 from a lower to a higher oxidation state, thereby enhancing the performance of a precipitation system to remove the inorganic contaminant from the fluid 104. In one exemplary embodiment, the inorganic contaminant is arsenic, and NTP injection serves to oxidize at least a portion of the arsenic from a +3 oxidation state to a +5 oxidation state, thereby enhancing removal of the arsenic from the fluid by the at least one complementary treatment component 120, 122. In an embodiment, the at least one complementary treatment component 120, 122 comprises a precipitant including a rare earth element. In an embodiment, the rare earth element is cerium. In an embodiment the precipitant comprises an inorganic rare earth compound. In various embodiments the precipitant is insoluble in the fluid before and after precipitating or otherwise removing the contaminant from the fluid 104

In various embodiments, the NTP treatment and the at least one complementary treatment component 120, 122 comprise sequential treatment steps, with the complementary treatment component 122 located functionally downstream of the one or more NTP injection device 106, or a substantially simultaneous treatment wherein the complementary treatment component 120 and the one or more NTP injection device 106 are functionally colocated. In other embodiments, two or more complementary treatment components 120, 122 are present. The at least one complementary treatment component can have any physical configuration that provides interaction with a portion of the fluid 104 to be treated. In various embodiments the at least one complementary treatment component comprises one or more of a porous block of a treatment material, an aggregate incorporating solid pieces of the treatment material, an array of tubes incorporating the treatment material and a slurry including particles of the treatment material through which the fluid 104 can flow, percolate, or otherwise be exposed. In an embodiment, the treatment material is bonded to or otherwise retained by a substrate. In an embodiment, the substrate is configured as a porous or otherwise high surface area material such as a porous ceramic block, for example, fabricated from alumina ceramic.

In one embodiment, the one or more NTP injection device 106 replaces a chemical oxidation component in a rare-earth based fluid treatment system, thereby reducing the quantity of rare earth material required to operate the system to remove a predetermined quantity of contaminant. For example, Witham et al. discloses the use of a rare earth containing oxidizing agent and a rare earth containing precipitating agent for removing arsenic from aqueous streams, where the two components can be co-located or sequentially located in the stream. Whereas current NTP devices themselves do not remove arsenic from aqueous streams, their oxidative capability can complement the functionality of rare earth precipitants and are anticipted to reduce the quantity of rare earth material required to treat an arsenic-contaminated fluid, relative to a treatment system including a rare earth oxidizing agent, or other known solid or suspended chemical oxidizer. In one embodiment, a slurry or an aggregate of solid particles serving as a treatment material in a precipitation system are exposed to activated gas provided by NTP injection devices to enhance the performance of the precipitation system. In another embodiment, the NTP injection functionally replaces a chemical oxidation component of the precipitation system.

Further, the oxidizing capabilities of oxygen-bearing NTP injection devices are anticipated to reduce organic contamination and thereby extend the operational lifetime of some fluid treatment systems by oxidizing organic or biological contaminants that otherwise can clog filtration components, or coat or otherwise spoil catalytic or reactive surfaces of known treatment materials or other treatment system components.

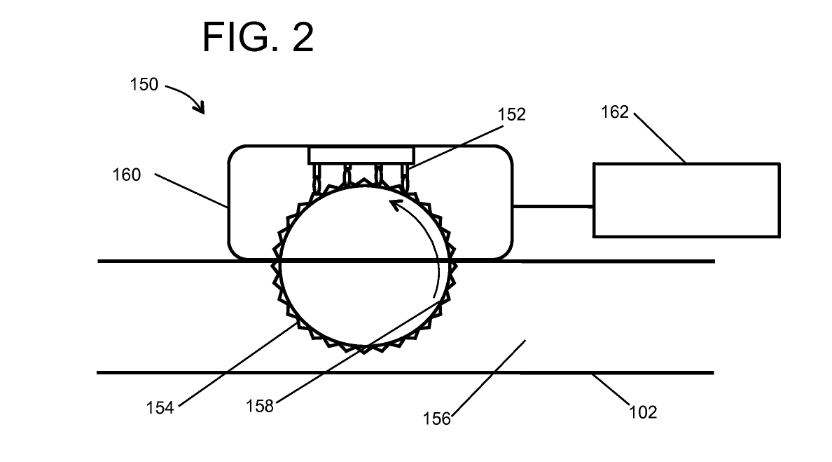

FIG. 2 schematically illustrates a fluid stream treatment system 150 wherein one or more NTP injector 152 is configured for off-line conditioning of a treatment material 154 that can be continuously or periodically cycled in and out of a process stream 156, for regeneration, reactivation, recycling, decontamination before disposal, or any process comprising NTP that increases operational life or enables continuous or improved duty cycle treatment of the process stream 156. Any means of transporting or cycling the treatment material 156 can be used. In an embodiment, the transport is effected using one of a moving belt and a rotating drum 158 cycling between the process stream 156 and a conditioning assembly 160 including the one or more NTP injector 152 as illustrated in FIG. 2. In an embodiment, the treatment material 154 comprises one or more of a filter and a slurry an aggregate of treatment chemicals. Alternatively, a treatment material can be cycled into and out of the process stream 158 in a batch process, for example, in a manually or automatically replaceable cartridge, for conditioning or reconditioning off line. Gas and power supply components 162 can comprise any of the embodiments disclosed in association with FIGS. 1A and 1B. Exposing a treatment material to NTP treatment out of the process stream 156 enables the NTP treatment to be performed in a dry or relatively dry environment, where control and direction of gas jets from the NTP injectors 152, as well as associated chemical processes and windowless light exposure originating in the NTP, for example, for surface sterilization, may be more simply engineered than for operation immersed in a liquid.

In yet other embodiments, NTP injectors according to the present invention are used to inject activated gas bearing transient species into an aerosol of a fluid medium to be treated, thereby enhancing contact and mixing between gas exiting the NTP injector and the fluid medium. Injection into an aerosol can be employed either directly in a process stream as disclosed in association with FIG. 1A, or for the off-line conditioning disclosed in association with FIG. 2. In further embodiments, one or both of the aerosol and the NTP injection is directed at a treatment material that in various embodiments comprises one or more of a precipitant, a filter medium, an adsorbent for a contaminant, or another treatment material. Applying the NTP injectors into an aerosol of the fluid medium provides a high surface area for interaction between transient species from the NTP device and the fluid medium, and relieves engineering constraints associated with managing the dispersement of gas bubbles associated with immersion of the NTP device directly in a liquid.

An advantage of systems and processes according to the present invention is that NTP technology provides opportunities to use electrical energy to selectively drive chemical reactions, thereby replacing or reducing the consumption of one or more of mined, purchased and stored chemical reagents. Additional advantages of incorporating NTP injection into fluid treatment systems and methods include but are not limited to improved recycling or regeneration of treatment media for process streams. Another advantage is that ambient air or the fluid medium to be treated can be used to supply some types of gas for use in NTP injectors, reducing or eliminating these gas reagent costs. Further, incorporation of NTP technology presents opportunities to develop even more integrated treatment systems. For example, oxygen and nitrogen can be separated using membrane separators or any other gas separation technology known in this art, for separate use in nitrogen and oxygen NTP devices. For example, nitrogen-bearing NTP devices have been demonstrated to chemically reduce the nitrogen oxide content of combustion exhaust streams from diesel engines. Oxygen in air can be reacted with organic materials to produce carbon dioxide for use in a NTP injector. These and other gases, as well as various mixtures, can replace purchased and stored reagents that might otherwise be required for treating a process stream.

In some embodiments, electricity to power NTP injectors for treatment of a contaminated water stream is generated hydroelectrically from the energy of the stream's flow. Self-generation of electrical power to generate reagents for decontaminating a water supply provides opportunities for constructing self-sustaining treatment systems that can be particularly applicable in rural or less developed areas of the world, for example, where the replacement or recycling of filtering or other types of treatment media is logistically or economically problematic.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof. All publications and references cited herein are expressly incorporated herein by reference in their entirety.

What is claimed is:

1. A system for removing a contaminant from an aqueous medium, the system comprising:
a gas injector configured to electrically excite a gas and to inject the exited gas into the medium, the injected gas comprising a gaseous oxidant generated by the electrical excitation and having a persistence time in the gas of less than five seconds, the oxidant being operative to oxidize the contaminant from a first chemical state to a second chemical state; and
a precipitating agent in contact with the medium, the precipitating agent having a capacity to remove the contaminant from the medium, the capacity being greater for the contaminant in the second state than in the first state.

2. The system according to claim 1 wherein the persistence time is less than one second.

3. The system according to claim 1 wherein the persistence time is less than one hundred milliseconds.

4. The system according to claim 1 wherein the gas is injected at a gas temperature of less than four hundred degrees Celsius.

5. The system according to claim 1 wherein the gas is injected at a gas temperature of less than one hundred degrees Celsius.

6. The system according to claim 1 wherein the medium comprises a liquid in which at least a portion of the injector is immersed.

7. The system according to claim 1 wherein the medium comprises drops of liquid dispersed in a gas, the drops comprising the contaminant.

8. The system according to claim 1 wherein the oxidant comprises one or more of atomic oxygen, ionized molecular oxygen, an oxygen-containing chemical species excited above a ground quantum state, and hydroxyl.

9. The system according to claim 1 wherein the contaminant comprises arsenic in a +3 oxidation state and the oxidant is operative to oxidize the arsenic to a +5 oxidation state.

10. The system according to claim 9 wherein the precipitating agent is a rare earth precipitating agent that has a greater capacity to precipitate arsenic present in the +5 oxidation state, than its capacity to precipitate arsenic present in the +3 oxidation state.

11. The system according to claim 1 wherein the precipitating agent comprises cerium.

12. The system according to claim 1 wherein the precipitating agent is retained by a porous substrate.

13. The system according to claim 1 wherein the precipitating agent comprises one of a slurry and an aggregate.

14. The system according to claim 1 wherein the gas injector and the precipitating agent are configured proximate to one another so that a portion of the oxidant contacts the precipitating agent during the persistence time.

15. A method for removing arsenic in a +3 oxidation state from an aqueous medium, the method comprising:
oxidizing the arsenic from the +3 oxidation state to a +5 oxidation state by injecting a gaseous oxidant into the medium, the oxidant having a persistence time in the medium of less than five seconds; and
precipitating the arsenic from the medium by contacting the medium with a precipitating agent having a greater capacity to precipitate arsenic present in the +5 oxidation state, than its capacity to precipitate arsenic present in the +3 oxidation state.

16. The method according to claim 15 wherein the oxidant comprises one or more of atomic oxygen, ionized molecular oxygen, an oxygen-containing chemical species excited above a ground quantum state, and hydroxyl.

17. The method according to claim 15 wherein the precipitating agent is a rare earth precipitating agent.

18. The method according to claim 15 wherein the precipitating agent comprises cerium.

19. The method according to claim 15 wherein the medium comprises a liquid.

20. The method according to claim 15 wherein the medium comprises drops of liquid dispersed in a gas, the drops comprising the contaminant.
